(19) United States
(12) Patent Application Publication
(10) Pub. No.: US 2022/0318836 A1
(43) Pub. Date: Oct. 6, 2022

(54) INFORMATION PROVIDING METHOD AND ELECTRONIC APPARATUS PERFORMING THE SAME

(71) Applicant: Coupang Corp., Seoul (KR)

(72) Inventors: Seung Ho Jeong, Seoul (KR); Nicolas Maxence Patrick Marie Daudin, Seoul (KR); Duck Hyeon Yoo, Seoul (KR); Jae Jin Yun, Seoul (KR); Moon Hee Kim, Seoul (KR); Catherine Chang, Seoul (KR); Ji Hye Ha, Seoul (KR)

(21) Appl. No.: 17/318,901

(22) Filed: May 12, 2021

(30) Foreign Application Priority Data
Apr. 5, 2021 (KR) 10-2021-0043920

(51) Int. Cl. G06Q 30/02

(52) U.S. Cl. CPC G06Q 30/0222

(57) ABSTRACT

Provided is an information providing method of an electronic apparatus including acquiring information on or regarding an item and information on a user, confirming one or more promotional events related to the item, confirming whether each of the one or more promotional events is valid based on the information on the user and price information on the item, and providing discount price information on the item to which discount benefit information included in at least one of the one or more promotional events is applied based on whether each of the one or more promotional events is valid. Other example embodiments are possible.

### TECHNICAL FIELD

The following descriptions relate to an information providing method and an electronic apparatus for performing the same.

### DESCRIPTION OF THE RELATED ART

With the development of Internet technology and the spread of mobile terminals such as smartphones and tablet personal computers (PCs), an e-commerce market is being commercialized. In recent years, the proportion of items purchased by directly visiting offline stores is decreasing due to the spread of infectious diseases, while the proportion of items purchased online in the e-commerce market using mobile terminals is increasing rapidly.

In such an e-commerce market, transactions are made between purchasers and sellers through a network online, and items that have been ordered may be delivered to delivery destinations set by the purchasers through a delivery service.

For example, service providers providing the e-commerce publish information on an item and price information through online sales web pages or applications, and purchasers access the online sales web pages or applications to select items and complete payment and thus may receive the paid items from the service providers.

Meanwhile, in order to publicize items and promote sales, sellers who sell items may set various promotional events to provide discount benefits for specific items (or item groups) during a specific time.

In this regard, conventionally, users (purchasers) may directly download predetermined coupons from the online item sales pages in advance and directly apply the downloaded coupons in the process of paying for items to purchase the items at a price to which the coupon discount has been applied.

However, in the case of providing a discount event on the condition of users' participation, there may be cases in which users do not receive a discount because they have not received coupons by mistake even in a situation where they may receive a discount. Accordingly, user complaints may arise, and the users may feel resistance to a complex promotional event due to a hassle of confirming whether coupons are applicable one by one.

### SUMMARY

### Technical Goals

An aspect provides an information providing method of an electronic apparatus capable of automatically selecting an applicable promotional event based on a user and an item in an e-commerce system and providing discount price information reflecting a most profitable promotional event to the user, and an apparatus for performing the same.

### Technical Solutions

According to an aspect, there is provided an information providing method of an electronic apparatus including acquiring information on an item and information on a user, confirming one or more promotional events related to the item, confirming whether each of the one or more promotional events is valid based on the information on the user and price information on the item, and providing discount price information on the item to which discount benefit information included in at least one of the one or more promotional events is applied based on whether each of the one or more promotional events is valid.

According to another aspect, there is provided an electronic apparatus including a communication module, a database, and a processor electrically connected to the database, in which the processor is configured to perform acquiring information on an item and information on a user through the communication module, confirming one or more promotional events related to the item, confirming whether each of the one or more promotional events is valid based on the information on the user and price information on the item, and providing discount price information on the item to which at least one of the one or more promotional events is applied based on whether each of the one or more promotional events is valid.

### Effects

According to various embodiments, it is possible to minimize a hassle that a user may feel during a purchase process by allowing an electronic apparatus to automatically provide discount price information reflecting a most profitable promotional event to a user (purchaser) based on information on a user and information on an item in an e-commerce system, and it is possible to relieve user's anxiety, make a user feel satisfied when purchasing an item, and encourage a user to purchase an item at a discounted price by blocking situations in which the user unintentionally does not receive benefits.

### BRIEF DESCRIPTION OF THE DRAWINGS

FIG. 1 is a schematic diagram illustrating an information providing system according to various example embodiments of the present disclosure.

FIG. 2 is a schematic block configuration diagram of an electronic apparatus according to an example embodiment of the present disclosure.

FIG. 3 is a flowchart of an information providing method of an electronic apparatus according to an example embodiment of the present disclosure.

FIG. 4 is a flowchart illustrating a method of providing item sales-related information according to an example embodiment of the present disclosure.

FIG. 5 is a diagram schematically illustrating a user interface screen according to an example embodiment of the present disclosure.

FIG. 6 is a diagram schematically illustrating a user interface screen according to an example embodiment of the present disclosure.

FIG. 7 is a diagram schematically illustrating a user interface screen according to an example embodiment of the present disclosure.

FIG. 8 is a diagram schematically illustrating a user interface screen according to an example embodiment of the present disclosure.

FIG. 9 is a diagram schematically illustrating a user interface screen according to an example embodiment of the present disclosure.

FIG. 10 is a diagram schematically illustrating a user interface screen according to an example embodiment of the present disclosure.

### DETAILED DESCRIPTION

General terms that are currently widely used are selected as terms used in example embodiments in consideration of functions in the present disclosure but may be changed depending on the intention of those skilled in the art or a judicial precedent, the emergence of a new technique, and the like. In addition, in specific cases, there may be terms arbitrarily chosen by the applicant. In this case, the meaning of such a term will be described in detail in a corresponding description portion. Therefore, the terms used in the present disclosure should be defined on the basis of the meanings of the terms and the content throughout the present disclosure rather than the simple names of the terms.

Throughout the specification, unless otherwise designated, “including” any component means that other components may be further included rather than excluding other components. In addition, the terms “unit,” “module,” and the like described in the specification refer to a processing unit of at least one function or operation and may be implemented by hardware or software or a combination of hardware and software.

The expression “at least one of a, b, and c” described throughout the specification may include “a alone,” “b alone,” “c alone,” “a and b,” “a and c,” “b and c,” or “all of a, b, and c.”

A “terminal” described below may be implemented as a computer or a portable terminal that may access a server or other terminals through a network. Here, computers may include, for example, a notebook computer, a desktop computer, a laptop computer, and the like, which are equipped with a web browser, and portable terminals are wireless communication devices that ensure portability and mobility and may include, for example, all kinds of handheld-based wireless communication devices such as a communication-based terminal, a smartphone, and a tablet personal computer (PC) which support International Mobile Telecommunications (IMT), code division multiple access (CDMA), W-code division multiple access (W-CDMA), Long Term Evolution (LTE), etc.

Hereinafter, the example embodiments of the present disclosure will be described in detail with reference to the accompanying drawings so that those skilled in the art to which the present disclosure pertains may easily practice the present disclosure. However, the present disclosure may be implemented in various different forms and is not limited to the example embodiments described herein.

Hereinafter, the example embodiments of the present disclosure will be described in detail with reference to the accompanying drawings.

In describing the example embodiments, descriptions of technical contents that are well known in the technical field to which the present disclosure pertains and that are not directly related to the present disclosure will be omitted. This is to more clearly convey the gist of the present disclosure without ambiguity by omitting unnecessary descriptions.

For the same reason, some components in the accompanying drawings are exaggerated, omitted, or schematically illustrated. In addition, the size of each component does not entirely reflect the actual size. The same reference numerals are assigned to the same or corresponding components in each drawing.

Various advantages and features of the present disclosure and methods accomplishing them will become apparent from the following description of the example embodiments with reference to the accompanying drawings. However, the present disclosure is not limited to the example embodiments disclosed herein but may be implemented in various forms. The example embodiments make contents of the present disclosure thorough and are provided so that those skilled in the art can easily understand the scope of the present disclosure. Therefore, the present disclosure will be defined by the scope of the appended claims. Throughout the specification, like reference numerals denote like components.

In this case, it will be appreciated that each block of a processing flowchart and combinations of the flowcharts may be executed by computer program instructions. Since these computer program instructions may be installed in a processor of a general computer, a special purpose computer, or other programmable data processing apparatuses, these computer program instructions executed through the processor of the computer or the other programmable data processing apparatuses create a means for performing functions described in the block(s) of the flowchart. Since these computer program instructions may also be stored in a computer usable or computer readable memory of a computer or other programmable data processing apparatuses in order to implement the functions in a specific scheme, the computer program instructions stored in the computer usable or computer readable memory can also produce manufacturing articles including an instruction means for performing the functions described in the block(s) of the flowchart. Since the computer program instructions may also be installed in the computer or the other programmable data processing apparatuses, the instructions perform a series of operation steps on the computer or the other programmable data processing apparatuses to create processes executed by the computer, thereby running the computer, or the other programmable data processing apparatuses may also provide operations for performing the functions described in the block(s) of the flowchart.

In addition, each block may indicate some modules, segments, or codes including one or more executable instructions for executing a specific logical function(s). Further, it is to be noted that functions described in the blocks occur regardless of a sequence in some alternative example embodiments. For example, two blocks that are consecutively shown may in fact be simultaneously performed or performed in a reverse sequence depending on corresponding functions.

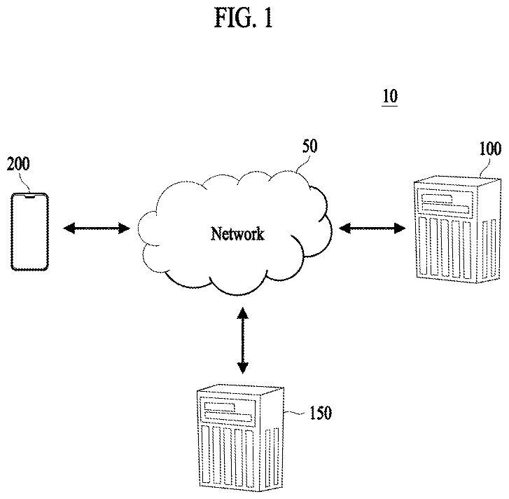

FIG. 1 is a schematic diagram illustrating a system for providing item-related information according to various example embodiments of the present disclosure.

According to various example embodiments, an information providing system 10 includes an electronic apparatus 100 (for example, a promotion management server), a second electronic apparatus 150 (for example, a front-end server), a user terminal 200, and a network 50.

The electronic apparatus 100 and the second electronic apparatus 150 are apparatuses that perform a series of function processes for providing various pieces of item sales-related information in e-commerce, and the electronic apparatus 100 and the second electronic apparatus 150 may perform preset operations based on a user input received from the user terminal 200 through the network 50 and provide information according to the preformed operations to the user terminal 200. For example, the electronic apparatus 100 and the second electronic apparatus 150 may include a plurality of computer systems or computer software implemented as a network server.

For example, the electronic apparatus 100 and the second electronic apparatus 150 may be referred to as the computer system and the computer software that are connected to a low-level apparatus capable of communicating with other network servers through a computer network such as the intranet or the Internet to accept a job execution request, execute the requested job, and provide the execution result. In addition, the electronic apparatus 100 and the second electronic apparatus 150 may be understood as a broad concept including a series of application programs that may operate on the network server and various databases built therein. For example, the electronic apparatus 100 and the second electronic apparatus 150 may be implemented using network server programs that are variously provided according to operating systems such as disk operating system (DOS), Windows, Linux, UNIX, or MacOS.

For example, the electronic apparatus 100 may function as the promotion management server that calculates, manages, and provides promotional event information available based on information on or regarding an item and a user, and the second electronic apparatus 100 may function as the front-end server that provides various pieces of item sales-related information (for example, the information on the item, a promotional event, and the like) in the form of a user interface displayed through web pages or applications. However, this is only an exemplary description, and according to various example embodiments of the present disclosure, the electronic apparatus 100 may correspond to a server that processes not only the functions of the promotion management server but also the functions of a front-end server.

The network 50 may serve to connect the electronic apparatus 100 to the user terminal 200 or connect the electronic apparatus 100 to another electronic apparatus (for example, the second electronic apparatus 150). For example, the network 50 may provide an access path so that the user terminal 200 or the second electronic apparatus 150 may be connected to the electronic apparatus 100 to transmit and receive packet data.

For example, the user terminal 200 may be connected to the electronic apparatus 100 or the second electronic apparatus 150 through the network 50 to transmit and receive item sales-related information for implementing an e-commerce transaction.

The electronic apparatus 100 or the second electronic apparatus 150 may store information received from the user terminal 200 or other external apparatuses in a database of each device or transmit the information stored in the database to the user terminal 200 or the external apparatus.

Meanwhile, according to various example embodiments, at least some of the functions that may be processed by the electronic apparatus 100 or the second electronic apparatus 150 may be implemented by the user terminal 200. For example, a user may receive an application type information providing system-related program through the network 50 and install and use the received program in the user terminal 200, and the application type program may instead perform at least some of the functions processed by the electronic apparatus 100 or the second electronic apparatus 150 to be described below.

The information providing system 10 according to various example embodiments may be implemented as a single physical device or may be implemented in a manner in which a plurality of physical devices are organically combined. For example, some of the functions provided by the electronic apparatus 100 may be implemented by any one physical device, and the rest of the functions may be implemented by other physical devices. For example, any one of the physical devices may be implemented as a part of the electronic apparatus 100, and other physical devices may be implemented as a part of the user terminal 200 or as a part of the second electronic apparatus 150 or other external apparatuses. In some cases, each of the components included in the information providing system is distributed and arranged in different physical devices, and the distributed and arranged components may be organically combined and implemented to perform the function and operation of the information providing system described herein.

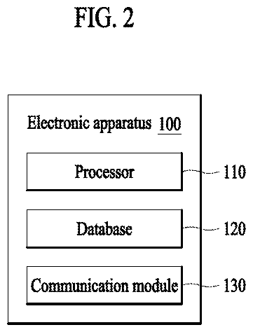

FIG. 2 is a schematic block configuration diagram of the electronic apparatus according to the example embodiment of the present disclosure.

Referring to FIG. 2, the electronic apparatus 100 (for example, a server) according to various example embodiments may include at least one of a processor 110, a database 120, and a communication module 130.

The processor 110 may process various functions for performing an information providing method according to various example embodiments of the present disclosure and may be electrically connected to other components (for example, the database 120 and the communication module 130) of the electronic apparatus 100 to control the overall operation of the components.

For example, the processor 110 may acquire information on a specific item (for example, a first item) and information on a user by using the communication module 130 and may confirm one or more promotional events related to the item (first item) based on the acquired information on the item.

For example, the processor 110 may confirm at least one of the item or a promotional event corresponding to category information on the item among various promotional event(s) previously stored in the database 120. For example, the processor 110 may select and confirm only the promotional event determined to have not expired from among the promotional events related to the item. For example, a specific promotional event may expire when a preset expiration date (for example, an event is applicable from February 2021 to March 2021) passes. Alternatively, the specific promotional event may expire according to setting of a seller who has set an event (for example, the event is automatically terminated when, in an event for all users, the users participate in the event 5000 times), receiving an input related to the event termination, or the like. The processor 110 may exclude the expired promotional event from a subject of confirmation of an item-related promotional event.

Meanwhile, the processor 110 may determine the validity of each of the one or more promotional event(s) confirmed in relation to the item. For example, the processor 110 may identify whether each of the promotional events may be validly used by the user based on at least one of information on user (for example, whether the user is signed up for membership, user purchase history, and the like), and price information on an item.

For example, each of the promotional events may include a predetermined condition(s) related to validity. For example, a certain promotional event may include a condition (for example, available only to users who are signed up for a membership, only users belonging to a specific membership level, or the like) related to user membership information, a condition (for example, applicable only when purchasing a specific item for the first time, applicable only once a week, or the like) for a count limit available for each user, or a condition (for example, available only when a price of a purchased item is 10,000 won or more or the like) related to prices of items (or items belonging to the category of the item). The processor 110 may confirm whether each of the promotional events is valid based on information on a user's membership level or whether a user is signed up for membership or confirm whether the promotional event is valid based on price information on an item.

In addition, when a plurality of promotional events determined to be valid are confirmed, the processor 110 may calculate discount price information on an item by applying discount benefit information included in at least one of the promotional events and provide the calculated discount price information to other apparatuses (for example, the second electronic apparatus 150 or the user terminal 200). For example, the processor 110 may extract one or more promotional events corresponding to a combination of the promotional events most profitable to a user from the promotional events identified to be valid through a series of processing processes and apply the discount benefit information included in the event to the price of the item, thereby calculating the discount price information on the item.

For example, the processor 110 may provide related information such that the discount price information on the item is output to a user interface indicating item sales- related information. For example, the discount price information on the item may be provided together with price information prior to discounting the item or information related to an event to which the discount has been applied.

In addition, the processor 110 may implement various functions related to information provision according to various example embodiments of the present disclosure to be described below.

The database 120 has a data structure implemented in a predetermined storage space of the electronic apparatus 100, and thus, functions such as storing, searching, deleting, editing, or adding data may be freely performed. For example, the database 120 may include fields or components for processing functions such as storing, searching, deleting, editing, or adding data.

The database 120 may store data related to various functions of the electronic apparatus 100. For example, the database 120 may store various types of data related to an information providing method according to various example embodiments of the present disclosure and may store instructions or data for an execution operation of the processor 110.

The communication module may perform a function of transmitting information stored in the database 120 of the electronic apparatus 100 or predetermined information processed by the processor 110 to other apparatuses or allowing the electronic apparatus 100 to receive information from the other apparatuses. For example, the communication module 130 may receive predetermined user input information (for example, item of interest setting input, item search input, delivery address setting input, payment request input, and the like) from the user terminal 200. For example, the communication module 130 may include a transceiver for transmitting and receiving information.

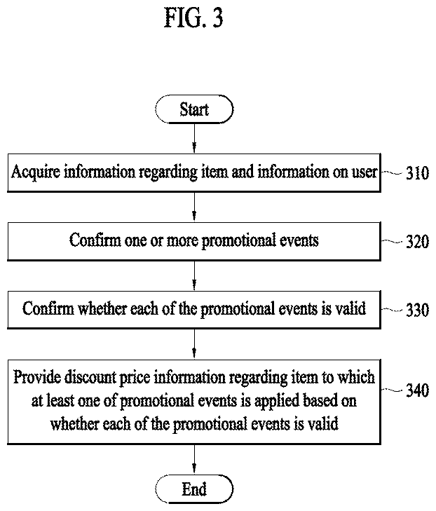

FIG. 3 is a flowchart of an information providing method of an electronic apparatus according to an example embodiment of the present disclosure.

Referring to FIG. 3, according to an information providing method according to various example embodiments, the electronic apparatus 100 (for example, the processor 110 in FIG. 2) may acquire information on an item and information on a user in operation 310.

For example, the electronic apparatus 100 may acquire at least one of the information on the specific item selected through the user terminal 200 and the information on the user corresponding to the user terminal 200.

For example, the electronic apparatus 100 may obtain the information on the item and the information on the user from at least one of the second electronic apparatus 150 (for example, a front-end server) or the user terminal 200.

According to an example embodiment, the information on the item acquired by the electronic apparatus 100 may include information on item(s) included in a search result list of items retrieved by a user through the user terminal 200. According to another example embodiment, the information on the item may include information on item(s) included in a list of recommended items to be provided from the second electronic apparatus 150 to the user terminal 200.

For example, the information on the item may include at least one of identification information on an item, price information (for example, sales price information before discount of an item) on an item, and category information on an item.

According to an example embodiment, the information on the user acquired by the electronic apparatus 100 includes user identification information, user delivery address information (for example, basic delivery destination information, recent delivery destination information, and the like), information related to a list (for example, shopping cart list) of specific items selected by a user, purchase history information of a user, and information related to membership subscription of a user.

Meanwhile, the electronic apparatus 100 may store at least one of the acquired information on an item and information on a user in the database 120 of the electronic apparatus 100.

In operation 320, the electronic apparatus 100 (for example, the processor 110) according to various example embodiments may confirm information on one or more promotional events related to the item based on the information on the item obtained in operation 310.

For example, the electronic apparatus 100 may store data related to various promotional events currently provided in the database 120 in advance. For example, the electronic apparatus 100 may manage various promotional events related to item sales in a manner of deleting an expired promotional event from the database 120 based on expiration date information set for each of the promotional events and storing the newly created promotional event in the database 120. In addition, the electronic apparatus 100 may delete expired events from the database 120 based on a preset usage count-related condition (for example, setting to terminate the event when selling 5000 items, and the like) when receiving information related to the termination of a promotional event according to setting of a seller.

According to an example embodiment, one or more promotional events managed by the database 120 may be determined based on inventory information (for example, inventory quantity information on an item) of a fulfillment center selected based on the information on the item and the information on the user acquired in operation 310. For example, the fulfillment center may be selected based on delivery destination information (for example, delivery destination information applied at the time of a recent purchase, default delivery destination information, or the like) of a user. For example, the electronic apparatus 100 may receive the inventory information (for example, a distribution management server) on the item in the selected fulfillment center from an external apparatus. For example, the electronic apparatus 100 may generate a promotional event related to the item or adjust discount benefit information of a previously created promotional event based on an inventory amount of the item in the fulfillment center. For example, the electronic apparatus 100 may create a promotional event related to the item or increase discount benefits (for example, a discount amount, a discount rate, a discount upper limit amount, and the like) of the previously created event when the inventory amount of the item in the selected fulfillment center is greater than or equal to a set value. In addition, the electronic apparatus 100 may terminate the promotional event or decrease the discount benefits (for example, a discount amount, a discount rate, a discount upper limit amount, and the like) included in the promotional event when the inventory amount of the item in the fulfillment center is less than the set value and the promotional event related to the item existed already.

Meanwhile, the electronic apparatus 100 may selectively identify the promotional event related to the item from the database 120 based on acquiring the information on the specific item.

For example, the electronic apparatus 100 may identify a first promotional event corresponding to a specific item and a second promotional event corresponding to the category (for example, item vendor type, item group type, and the like) of the item.

For example, when the specific item is “company X's A tissue,” the electronic apparatus 100 may confirm a promotional event (for example, a promotional event to which a discount is applied as soon as the item is purchased) corresponding to the “company X's A tissue” as the first promotional event corresponding to the item. In addition, the electronic apparatus 100 may confirm at least one of a promotional event corresponding to various items manufactured or sold by, for example, “company X” and a promotional event corresponding to items (for example, “A tissue,” “B tissue,” “C paper towel,” and the like) corresponding to a “tissue”-related category, as the second promotional event corresponding to the category of the item.

Next, in operation 330, the electronic apparatus 100 (for example, the processor 110) according to various example embodiments may confirm whether each of the promotional events confirmed in operation 320 is valid.

For example, the electronic apparatus 100 may confirm whether each of the promotional events is valid based on at least one of the information on the user and the price information of the item. Here, whether the promotional event is valid may be related to whether the user may apply the promotional event to the item.

According to an example embodiment, the electronic apparatus 100 may confirm whether each item-related promotional event confirmed in operation 320 is valid based on the membership-related information of the user.

For example, information on usage conditions related to whether the user is signed up for membership or the user's membership level may be set. The electronic apparatus 100 may confirm whether the information on the user related to the membership satisfies the usage conditions set in each promotional event, and the electronic apparatus 100 may determine that a promotional event satisfying the usage conditions is a valid promotional event.

For example, a promotional event according to an example embodiment may be set to be available only to members who have subscribed to a specific membership service, and a promotional event according to another example embodiment may be set to be available only when a user's membership level satisfies a specified level condition (for example, VIP level).

For example, the electronic apparatus 100 may upgrade the user's membership level when the user purchases the item(s) in excess of the specified number of times of purchases or the specified purchase price for a predetermined period, and when the promotional event corresponding to the upgraded membership level is confirmed in operation 320, the electronic apparatus 100 may determine that the promotional event is a valid promotional event in relation to the user.

According to an example embodiment, the promotional event may include a condition related to the applicable number of times of promotions. For example, a condition may be set so that a promotional event may be used up to a total of N times (for example, once) per user regardless of the period. As another example, a condition may be set so that the promotional event may be used a specified number of times (for example, up to once a day) within a specified period for each user. The electronic apparatus 100 may determine whether a promotional event is valid in relation to the applicable number of times based on the existing purchase history information of the user.

Meanwhile, according to an example embodiment, the electronic apparatus 100 may confirm whether each item-related promotional event extracted in operation 320 is valid based on the price information on the item. For example, one or more promotional events may include a condition (for example, a minimum purchase price condition) related to a purchase price of an item.

For example, one promotional event may be set to be applicable only when a price of an item is higher than or equal to a specified price (for example, 20,000 won). When a price of a specific item is 25,000 won, the electronic apparatus 100 may confirm that the price condition (for example, the purchase item price is higher than or equal to 20,000 won) set for the promotional event is satisfied and determine that the promotional event is valid in relation to the item.

According to one embodiment, in determining whether the condition related to the price of the item is satisfied, the electronic apparatus 100 may consider information on one or more items included in an item list (for example, a shopping cart list) selected by a user together with the item. In this case, the information on whether the promotional event determined in consideration of the item list selected by the user is valid may be managed differently from the validity determination information not considering the item list.

Next, in operation 340, the electronic apparatus 100 (for example, the processor 110) may confirm the discount price information on the item to which at least one of the promotional events is applied based on the information on whether each of the promotional event determined in the above-described operation 330 is valid and provide the confirmed discount price information.

The electronic apparatus 100 may confirm one or more promotional events determined to be valid in operation 330 among the promotional events extracted in operation 320. For example, the electronic apparatus 100 may identify a valid promotional event based on at least one of information on a user and price information on an item among one or more promotional events corresponding to a specific item or a category of an item and may determine at least one of the valid one or more promotional events to be applied to an actual item.

For example, the electronic apparatus 100 may confirm whether each of the promotional events may be redundantly applied.

The electronic apparatus 100 may select a promotional event capable of providing the highest discount price in relation to the item among the promotional events of which the redundant application is limited and may determine discount price information on an item by applying at least one of the selected promotional events and each of the promotional events that may be redundantly applied. In addition, the electronic apparatus 100 may provide the determined discount price information on the item to the second electronic apparatus 150 or the user terminal 200.

Meanwhile, the electronic apparatus 100 may confirm whether each of the promotional events is valid in consideration of the item-related information included in the item list (for example, shopping cart list) selected by the user based on the information on the user, and calculate second discount price information on an item to which at least some of the promotions are applied according to whether each of the promotional events confirmed to be valid may be redundantly applied. The second discount price information may correspond to information on an estimated discount price that may be applied when a user purchases items together with the item(s) included in the item list.

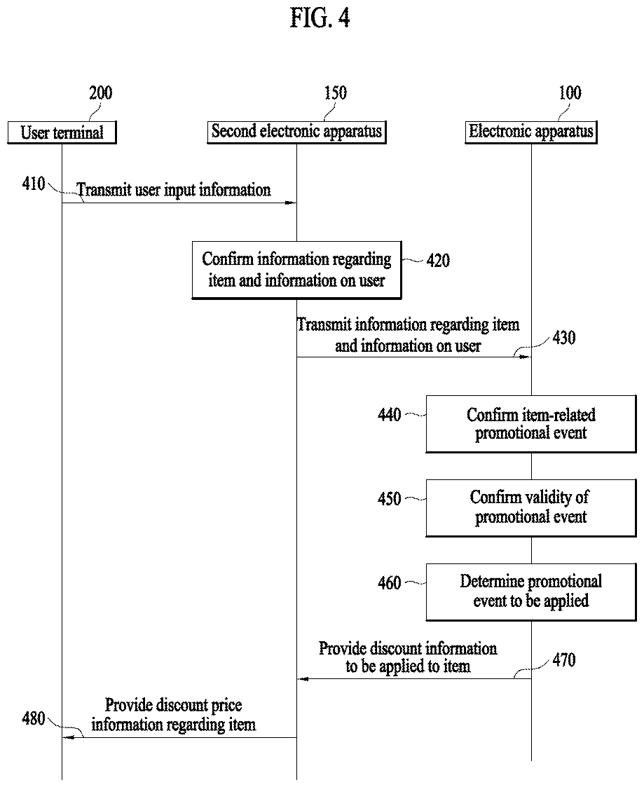

FIG. 4 is a flowchart illustrating a method of providing item sales-related information according to an example embodiment of the present disclosure.

Referring to FIG. 4, a method of providing item sales-related information according to various example embodiments may be performed based on the information transmission/reception and information processing operation between the electronic apparatus 100, the second electronic apparatus 150, and the user terminal 200. For example, the electronic apparatus 100 may correspond to the promotion management server that manages various promotional events related to item sales, and the second electronic apparatus 150 may correspond to the front-end server that provides the item sales-related information to be displayed on the user terminal 200 in the form of the user interface or receives a predetermined user input from the user terminal 200.

According to an example embodiment, in operation 410, the second electronic apparatus 150 may receive user input information from the user terminal 200. For example, the user input information may include various pieces of information such as a user input for switching an interface screen displayed on the user terminal 200, a user input for selecting a specific item, a user input related to a search term for a specific item, other user login inputs, or a delivery address input.

The second electronic apparatus 150 may confirm the predetermined information on an item and information on a user corresponding to the user input information in operation 420 and transmit the information on the item and the information on the user to the electronic apparatus 100 in operation 430.

The electronic apparatus 100 may confirm at least some of the promotional events applicable to the user corresponding to the information on the user among the promotional events related to the first item corresponding to the information on the item based on receiving the information on the item and the information on the user from the second electronic apparatus 150, calculate discount information on the first item to which the promotional event(s) that is most profitable to the user is applied, and provide the calculated discount information to the second electronic apparatus 150.

For example, in operation 440, the electronic apparatus 100 may confirm information on promotional events related to the first item. For example, the information on the promotional event related to the first item may include information on the first promotional event corresponding to the first item and the second promotional event corresponding to a category of the first item.

For example, the first promotional event may correspond to a promotional event set to be usable in the case of purchasing the first item, and the second promotional event may correspond to a promotional event set to be usable in the case of purchasing other items belonging to the same category as the first item as well as the first item.

According to an example embodiment, each promotional event(s) that the electronic apparatus 100 confirms in operation 440 satisfies preset usage period condition or a usage count-related condition and may correspond to a promotional event whose use has not expired when the electronic apparatus 100 confirms each promotional event(s). For example, at least one of a usage period limit condition (for example, available until Mar. 31, 2021) or the usage count-related condition (for example, available until a purchase of 5000 items in total is completed) may be set in each promotional event. In another example, the electronic apparatus 100 may confirm the expiration of the promotional event as the electronic apparatus 100 receives information related to a termination of a promotional event from a seller. For example, the electronic apparatus 100 determines whether the use of each of the promotional events has expired in real time or periodically and stores and manages only the promotional events that have not expired in the database 120, thereby selectively confirming only the promotional event(s) that have not expired among the promotional event(s) related to the first item.

In operation 450, the electronic apparatus 100 may determine the validity of each of the confirmed promotional events. For example, the validity determination may mean determination as to whether each of the promotional events may actually be used when the user purchases the first item.

According to an example embodiment, the electronic apparatus 100 may confirm a price limit condition (for example, a minimum purchase price condition) set in each of the promotional events and determine the validity of each of the promotional event based on whether the price of the first item satisfies the price limit condition. For example, the electronic apparatus 100 may determine that the promotional event is valid when the first item is higher than the minimum purchase price set in the promotional event. Meanwhile, according to an additional example embodiment, the electronic apparatus 100 may determine whether the promotional event is valid based on whether the sum of a price of other item(s) included in a shopping cart list corresponding to the information on the user as well as the price of the first item satisfies the price limit condition set in the promotional event.

According to an example embodiment, the electronic apparatus 100 may confirm user membership-related conditions set in each promotional event and determine the validity of the promotional event according to whether the information on the user satisfies the membership-related condition of the promotional event based on whether a user is signed up for membership or information on a user related to a user's membership level.

For example, a certain promotional event may be set to be applicable to anyone regardless of whether the user is signed up for membership or the user's membership level. In this case, the electronic apparatus 100 may determine that the promotional event is valid regardless of the information on the user. A certain promotional event may be set to be available only to members of a gold level or higher. In this case, the promotional event may be determined to be valid only when the corresponding user is the gold level or higher based on the information on the user.

According to an example embodiment, the electronic apparatus 100 may confirm the usage count-related condition set in each of the promotional events, confirm whether the user has a history of applying the promotional event based on the purchase history information of the user, and determine that a corresponding promotional event is not valid when the promotional event has already been used a set number of times or more. According to another example embodiment, the electronic apparatus 100 may determine whether a promotional event set to be applicable only when the user purchases the item (or other items corresponding to the category of the item) a predetermined number of times or more is valid based on the purchase history information of the user. For example, a certain promotional event may be provided as a concept of compensation to a user who has purchased the same item (or other items corresponding to the category of the item) a specified number of times or more (for example, 10 times), and the electronic apparatus 100 may confirm whether the promotional events are valid based on the purchase history information of the user.

According to an example embodiment, the electronic apparatus 100 may confirm whether payment type information preset by the user satisfies a payment type-related condition (for example, an event is applicable when paying by a specific credit card or using specific points) set in a promotional event based on information on a payment method preset by the user and may determine that the promotional event is valid when determining that the user satisfies the payment type-related condition.

Next, in operation 460, the electronic apparatus 100 may determine one or more promotional events to be applied to the first item based on the information on the promotional event related to the first item that has been confirmed to be valid.

For example, each promotional event(s) may be classified into a promotional event that is applicable in redundancy with another promotional event and a promotional event of which the redundant application is limited.

The electronic apparatus 100 may confirm the number of cases for various combinations of the valid promotional event(s) related to the first item based on characteristic information on whether the redundant application included in each piece of the promotional event information is available and may compare item discount amounts when one or more promotional events are applied according to each combination.

For example, a certain promotional event may be an event that provides a discount (for example, 2,000 won discount) of a specified amount from an item price, and another promotional event may be an event that provides a discount at a specified discount rate (for example, 10% discount). In addition, for at least some of the discount rate-related events, a maximum discount limit amount (for example, a maximum discount of 5,000 won) may be preset. The electronic apparatus 100 may determine the promotional event(s) corresponding to the combination with the largest discount amount as the promotional event(s) to be applied to the first item based on a discount limit, a discount amount, and a discount rate for each promotional item, and related information on whether each of the promotional items is redundantly applicable.

In operation 470, the electronic apparatus 100 may transmit discount information (for example, promotional event information, discount amount information, sales price information to which a discount is applied, and the like) to be applied to the first item to the second electronic apparatus 150.

In addition, in operation 480, the second electronic apparatus 100 may configure the discount price information on the item in the form of the user interface and provide the configured discount price information to the user terminal 200.

According to an example embodiment, the second electronic apparatus 100 may display the discount price information of the first item on a first user interface indicating the information related to the sales of the first item.

For example, the first user interface may correspond to a page that provides information on a search result of an item, a page that provides recommended item-related information, or a page that provides detailed information on an item.

The second electronic apparatus 100 may provide both the sales price information (for example, an undiscounted price) on the first item and the discount price information on the first item on the first user interface. For example, the second electronic apparatus 100 draws a strikethrough on general sales price information and highlights the discount price information (for example, bold, large font, different color display, and the like) so that the two pieces of information may be differentiated from each other.

Meanwhile, the electronic apparatus 100 according to the example embodiment may reconfirm the valid promotional event(s) that may be applied when purchasing the first item and the item(s) of the shopping cart list together based on the information (for example, the category information on each item(s) and/or the price information) on the item(s) included in the shopping cart list corresponding to the user, reselect one or more promotional events corresponding to the combination with the greatest discount among the reconfirmed valid promotional event(s), and confirm the estimated discount price information (second price information) when the reselected one or more promotional events are applied. The second electronic apparatus 150 may receive and provide the estimated discount price information (second price information) for the first item.

For example, the second electronic apparatus 150 may classify the discount price information (first discount price information) determined without considering the shopping cart list corresponding to the user and the estimated discount price information (second discount price information) determined in consideration of the shopping cart list and may provide the classified discount price information and estimated discount price information to the user terminal 200.

For example, the second electronic apparatus 150 may display the first discount price information and the second discount price information on different interfaces related to item sales. For example, the second electronic apparatus 150 may display the second discount price information on the second user interface indicating the information related to the shopping cart list and display the first discount price information on other user interfaces (for example, the first user interface) except for the second user interface.

As another example, the second electronic apparatus 150 may display the second discount price information on other user interfaces (for example, the first user interface) except for the second user interface related to the shopping cart list. For example, the second electronic apparatus 150 may display the information (for example, information indicating that purchase is possible at a corresponding price when purchasing together with the shopping cart item) indicating that the second discount price information is calculated in consideration of the shopping cart list together with the second discount price information. For example, the second electronic apparatus 150 may display, on the first user interface, information on a price before the discount of the first item, information on a first discount price of the first item, and information on a second discount price, respectively.

According to another example embodiment, the second electronic apparatus 150 may receive the condition-related information related to the promotional event that the electronic apparatus 100 determines to be invalid in operation 450 and provide the received condition-related information to be displayed on the user terminal 200. For example, when the electronic apparatus 100 determines that a specific promotional event having a large discount benefit in relation to the first item is not valid, the electronic apparatus 100 may provide the information (for example, “discount available when being signed up for membership,” “discount available for purchases of 30,000 won or more,” “discount available for two additional purchases of related items,” and “requires payment by XX card,” or the like) on the condition of applying for the promotional event. As a result, it is possible to induce specific user actions related to payment, such as changing the setting to sign up for specific membership or purchase using a specific payment method.

Meanwhile, the electronic apparatus 100 according to various example embodiments may perform at least some operations described as being performed by the second electronic apparatus 150 in FIG. 4 instead of the second electronic apparatus 150.

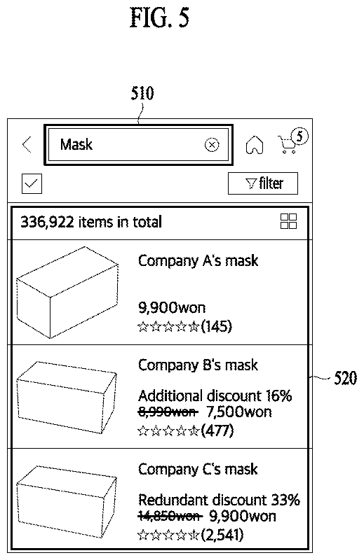

FIGS. 5 to 10 are diagrams schematically illustrating user interface screens according to various example embodiments of the present disclosure.

According to various example embodiments, the electronic apparatus 100 (or the second electronic apparatus 150) may provide item sales-related information in the form of a user interface.

For example, the electronic apparatus 100 (or the second electronic apparatus 150) according to the example embodiment may provide sale-related information on at least one item (for example, company A's mask, company B's mask, and company C's mask) as search result information 520 on a search term in response to inputting a related search term 510 (for example, mask) by a user to search for a specific item, as illustrated in FIG. 5.

The electronic apparatus 100 (or the second electronic apparatus 150) includes at least one of sales price information corresponding to each item and discount price information reflecting a promotional event applicable to the item on the interface related to the item search result.

For example, the electronic apparatus 100 may determine that a promotional event applicable to the item does not exist for a certain item (for example, company A's mask). In this case, the electronic apparatus 100 (or the second electronic apparatus 150) may provide only the sales price information (for example, 9,900 won) on the item to the user interface and may not provide the discount price information on the item separately.

For example, in the case of a specific item (for example, company B's mask, company C's mask), the electronic apparatus 100 may confirm that there is a predetermined promotional event information that may be applied to each item based on the information on the item and the information on the user and thus may provide both the sales price information (for example, 8,990 won and 14,850 won) on the item and the discount price information (for example, 7,500 won and 9,900 won) on the item to the user interface. For example, the electronic apparatus 100 (or the second electronic apparatus 150) may provide sales price information before discount of an item and discount price information on an item in a manner that the sales price information and the discount price information are differentiated from each other. For example, the sales price information before the discount of the item may be displayed in a strikethrough form, and the discount price information may be highlighted in a manner of displaying in bold, highlight, a larger size, or the like. Meanwhile, the electronic apparatus (or the second electronic apparatus 150) according to various example embodiments may provide discount rate-related information (for example, 16% and 33%) together with the discount price information on the item, and/or attribute information of the promotional event (for example, “applying additional discount,” “applying redundant discount,” and the like).

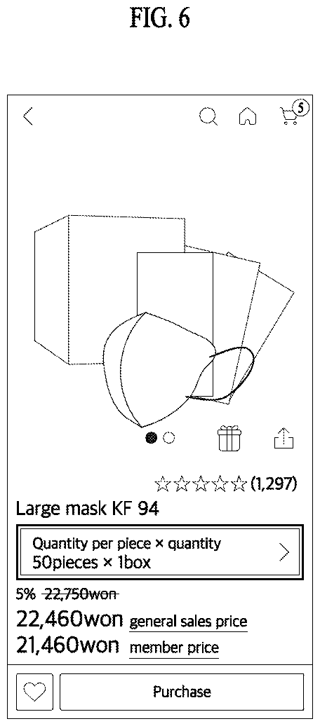

Meanwhile, the electronic apparatus 100 (or the second electronic apparatus 150) according to the example embodiment may provide an item sales-related user interface indicating the detailed information on the item, as illustrated in FIG. 6.

For example, the electronic apparatus 100 (or the second electronic apparatus 150) may provide detailed information related to item sales, sales price information (for example, 22,750 won) of an item before a promotional event is applied, and discount price information (for example, 22,460 won and 21,460 won) of an item to which a promotional event is applied.

For example, when a specific promotional event related to an item includes condition information on whether a user is signed up for membership, the electronic apparatus 100 (or the second electronic apparatus 150) may provide both the discount price information (for example, 21,460 won—member price) to which the membership-related promotional event is applied and the discount price information (for example, 22,460 won—general sales price) to which the membership-related promotional event is not applied.

A user corresponding to the user terminal 200 on which the display screen is output may be in a state of being signed up for membership or a state of not being signed up for membership. For example, when the user has been already signed up for membership, the user may confirm the estimated price and the estimated discount rate information when the item is purchased by himself or herself through the discount price information to which the membership-related promotional event is applied, thereby determining whether to purchase. In addition, even when the user is not signed up for the membership, the user may check the benefit information that may be received through membership subscription by simultaneously confirming the discount price information to which the membership-related promotional event is applied and the discount price information to which the membership-related promotional event is not applied and may purchase the corresponding item at the general sales price or purchase the item at the member price after the user is signed up for the membership.

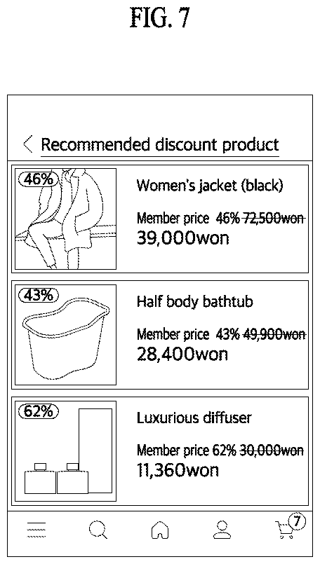

In addition, the electronic apparatus 100 (or the second electronic apparatus 150) may provide information on recommended discount sales items on the user interface, as illustrated in FIG. 7. For example, the electronic apparatus 100 (or the second electronic apparatus 150) may individually determine whether a promotional event is applied to each item and provide discount price information on an item to which each promotional event is applied. In one example, the electronic apparatus 100 (or the second electronic apparatus 150) may extract information on items discounted at a discount rate greater than or equal to a preset value as recommended discount sale items as one or more promotional events are applied and may provide the sale-related information (for example, at least one of a general sales price before discount of each item, a discount sale price to which a discount benefit is applied, a discount rate, and discount attribute information (for example, member price)) on the items.

On the other hand, the electronic apparatus 100 (or the second electronic apparatus 150) may provide a specific item(s) selected by a user, for example, at least one of the price information and the discount price information on each item(s) of the item list (for example, shopping cart list) set as an item of interest so that the user has not yet completed payment and may make payment later.

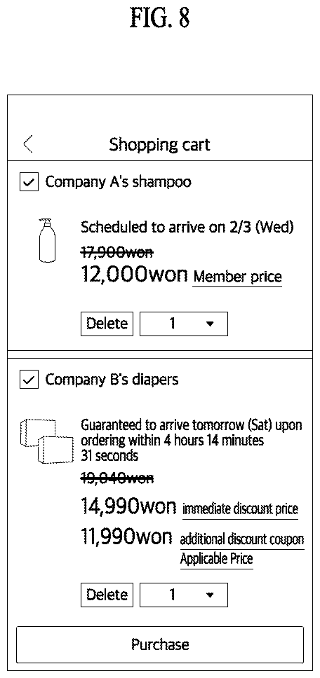

For example, as illustrated in FIG. 8, the electronic apparatus 100 (or the second electronic apparatus 150) may confirm one or more items (for example, company A's shampoo and company B's diapers) included in the shopping cart list corresponding to the user. In addition, the electronic apparatus 100 may identify valid promotional events corresponding to each of the items and calculate and provide discount price information on an item to which one or more promotional events of a combination that is most profitable to a user among the valid promotional events are applied.

For example, the electronic apparatus 100 (or the second electronic apparatus 150) may provide, as sale-related information on company A's shampoo, at least one of price information (for example, 17,900 won) on undiscounted Company A's shampoo, price information (for example, 12,000 won) of discounted Company A's shampoo, and discount-related attribute information (for example, “member price”). In addition, as sales information on Company B's diapers, at least one of general sales price information (for example, 19,040 won) before discount of Company B's diapers, discount price information (for example, 14,990 won) to which a specific promotional event that is applicable regardless of information on a user is applied, and discount price information (for example, 11,990 won) to which a promotional event which is redundantly applicable as membership-related promotional event applied based on information on a user is additionally applied, and each discount-related attribute information (for example, “immediate discount price,” “additional discount coupon application price,” and the like) may be provided.

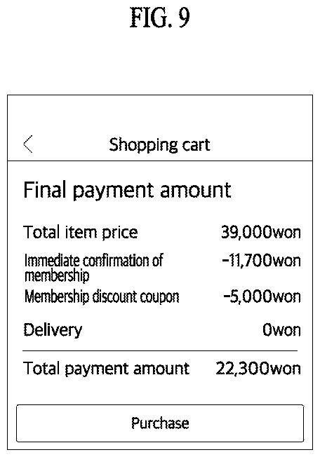

Meanwhile, as illustrated in FIG. 9, in the user interface related to the shopping cart list corresponding to the user, when paying for at least one item included in the shopping cart list, at least one of final payment amount information and discount benefit information and discount amount information on a promotional event applied to each item may be displayed.

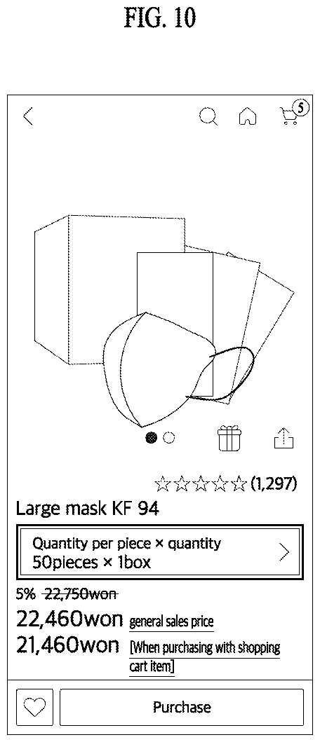

According to an example embodiment, when the electronic apparatus 100 (or the second electronic apparatus 150) determines whether a promotional event is valid based on the situation of purchasing a specific item alone, the electronic apparatus 100 determines that the promotional event is not valid based on the price information of the item or the like, but in the case where the electronic apparatus 100 determines whether the promotional event is valid in consideration of the situation of purchasing the item and other items included in the shopping cart list together, when there is the promotional event determined to be valid, as illustrated in FIG. 10, the electronic apparatus 100 may provide discount price information (for example, 21,460 won) on an item to which the promotional event is applied to be displayed on a user interface along with discount-related attribute information (for example, information indicating that the item may be applied when purchasing along with the shopping cart item).

For example, as a user confirms the user interface indicating detailed information on an item illustrated in FIG. 10, a discount price (for example, 22,460 won) when the item (for example, large mask KF94) is purchased alone may be compared with an estimated discount price (for example, 21,460 won) when the item is purchased along with the shopping cart item, and a user may purchase the item at an additionally discounted price along with the purchase of the item in the shopping cart list when he/she wants to receive more discount benefits as needed.

As another example, in one example embodiment, the electronic apparatus 100 (or the second electronic apparatus 150) may be set not to display the estimated discount price information determined in consideration of the shopping cart list in a sale-related information display term of individual items unlike a sales price of each item and a discount price of an item in order to prevent user confusion. In this case, the estimated discount price information determined in consideration of the shopping cart list may be provided only in the user interface displayed when the user finally wants to confirm payment, as illustrated in FIG. 9.

Meanwhile, the example embodiment of the present disclosure has been disclosed in the present specification and drawings, and although specific terms are used, these are merely used in a general sense to easily describe the technical content of the present disclosure and to aid in understanding of the present disclosure but are not intended to limit the scope of the present disclosure. It is obvious to those of ordinary skill in the art to which the present disclosure pertains that other modifications based on the technical idea of the present disclosure can be implemented in addition to the example embodiments disclosed herein.

The electronic apparatus or terminal according to the above-described example embodiments may include a processor, a memory that stores and executes program data, a permanent storage such as a disk drive, a communication port for communication with an external apparatus, a touch panel, a key, a user interface device such as a button, and the like. Methods implemented as software modules or algorithms may be stored on a computer-readable recording medium as computer-readable code or program instructions executable on the processor. Here, examples of the computer-readable recording medium may include magnetic storage media (for example, a read-only memory (ROM), a random-access memory (RAM), a floppy disk, a hard disk, etc.), optical reading media (for example, a compact disk (CD)-ROM or a digital versatile disc (DVD)), and the like. The computer-readable recording medium may be distributed in computer systems connected to each other through a network, and as a result, the computer-readable code may be stored and executed in a distributed scheme. The medium may be readable by a computer, stored in a memory, and executed on a processor.

The present example embodiment may be represented by functional block configurations and various processing operations. These functional blocks may be implemented by various numbers of hardware and/or software components that execute specific functions. For example, the example embodiment may employ integrated circuit configurations, such as a memory, processing, logic, and a look-up table, capable of executing various functions by control of one or more microprocessors or other control devices. Similar to executing the components in software programming or software elements, the present example embodiment can be implemented in programming or scripting languages such as C, C++, Java, Assembly, and Python including various algorithms implemented by a combination of data structures, processes, routines or other programming configurations. Functional aspects may be implemented in algorithms executed on one or more processors. In addition, the present example embodiment may employ a conventional technology for electronic environment setting, signal processing, and/or data processing, and the like. Terms such as “mechanism,” “element,” “means,” and “configuration” may be used broadly and are not limited to mechanical and physical configurations. The terms may include the meaning of a series of routines of software in connection with a processor or the like.

The above-described example embodiments are merely examples, and other example embodiments may be implemented within the scope of the following claims.

1. An information providing method of an electronic apparatus, comprising:
acquiring information regarding an item and information on a user;
confirming one or more promotional events related to the item;
confirming whether each of the one or more promotional events is valid based on the information on the user and price information regarding the item;
determining a delivery destination associated with the user;
identifying a fulfillment center based on the delivery destination;
receiving inventory information associated with the item for the fulfillment center, wherein the inventory information is indicative of an inventory amount of the item at the fulfillment center;
determining that a first inventory amount of the item at the fulfillment center is greater than a threshold value at a first time;
providing a first discount price information regarding the item for an e-commerce transaction based on the determination that the first inventory amount of the item at the fulfillment center is greater than the threshold value;
transmitting the first discount price information regarding the item to a device of the user for display on a user interface on the device, wherein the display of the first discount price information regarding the item on the user interface facilitates completion of the e-commerce transaction by the user;
detecting a change of the inventory of the item at the fulfillment center from the first inventory amount to a second inventory amount at a second time different from the first time, wherein the second inventory amount is less than the threshold value;
providing a second discount price information regarding the item for the e-commerce transaction based on a determination that the second inventory amount of the item at the fulfillment center is less than the threshold value;
transmitting the second discount price information regarding the item to a device of the user for display on a user interface on the device; and
in response to the user purchasing the item based on the second discount price information displayed on the user interface, causing the item to be delivered from the fulfillment center to the delivery destination;
wherein discount benefit information associated with at least one of the one or more promotional events are applied to the first discount price information and the second discount price information based on whether each of the one or more promotional events are valid.

2. The information providing method of claim 1, wherein the one or more promotional events comprise at least one of: a first promotional event corresponding to the item or a second promotional event corresponding to a category of the item.

3. The information providing method of claim 1, wherein:
the information on the user comprises information on one or more items included in an item list selected by the user,
the information providing method further comprises:
reconfirming whether the one or more promotional events are valid based on category information and price information corresponding to each of the one or more items included in the item list; and
providing second discount price information regarding the item, wherein at least one of the one or more promotional events is applied based on the reconfirming whether the one or more promotional events are valid.

4. The information providing method of claim 3, wherein the providing of the discount price information on the item comprises:
displaying the discount price information on the item via a first user interface showing sale-related information on the item; and
displaying the second discount price information on the item via a second user interface showing information related to the item list selected by the user, wherein the second user interface is different from the first user interface.

5. The information providing method of claim 3, wherein the providing of the discount price information on the item comprises providing the second discount price information on the item to a first user interface indicating sale-related information on the item.

6. The information providing method of claim 1, wherein the information on the user comprises at least one of: membership-related information of the user or purchase history information of the user.

7. The information providing method of claim 1, wherein the providing of the discount price information on the item comprises:
selecting one or more promotional events corresponding to a highest discount price based on at least one of: information on whether each of the promotional events is redundantly applicable, discount amount information, discount rate information, or discount limit information; and
providing the discount price information on the item, wherein the selected one or more promotional events are applied to the discount price information.

8. The information providing method of claim 1, wherein the one or more promotional events are determined based on inventory quantity-related information of a fulfillment center selected based on the information on the item and the information on the user.

9. The information providing method of claim 1, wherein the confirming of whether each of the one or more promotional events is valid comprises, based on purchase history information of the user included in the information on the user, confirming whether each of the one or more promotional events is valid based on whether the item or items of a category corresponding to the item have been purchased a specified number of times or more.

10. The information providing method of claim 1, wherein the confirming of whether each of the one or more promotional events is valid comprises, based on payment type information set by the user, determining one or more valid promotional events corresponding to a payment type condition of the one or more promotional events.

11. The information providing method of claim 1, further comprising, based on information on whether each of the one or more promotional events is valid, providing condition-related information related to a promotional event that is determined to be invalid among the one or more promotional events.

12. The information providing method of claim 1, wherein the confirming of the one or more promotional events comprises confirming the one or more promotional events that have not expired based on at least one of: preset usage period or usage count conditions in relation to each of the promotional events related to the item.

13. An electronic apparatus comprising:
a communication module;
a database; and
a processor electrically connected to the database,
wherein the processor is configured to perform steps of:
acquiring information regarding an item and information on a user through the communication module;
confirming one or more promotional events related to the item;
confirming whether each of the one or more promotional events is valid based on the information on the user and price information regarding the item;
determining a delivery destination associated with the user;
identifying a fulfillment center based on the delivery destination;
receiving inventory information associated with the item for the fulfillment center, wherein the inventory information is indicative of an inventory amount of the item at the fulfillment center;
determining that a first inventory amount of the item at the fulfillment center is greater than a threshold value at a first time;
providing a first discount price information regarding the item for an e-commerce transaction based on the determination that the first inventory amount of the item at the fulfillment center is greater than the threshold value;
transmitting the first discount price information regarding the item to a device of the user for display on a user interface on the device, wherein the display of the first discount price information regarding the item on the user interface facilitates completion of the e-commerce transaction by the user;
detecting a change of the inventory of the item at the fulfillment center from the first inventory amount to a second inventory amount at a second time different from the first time, wherein the second inventory amount is less than the threshold value;
providing a second discount price information regarding the item for the e-commerce transaction based on a determination that the second inventory amount of the item at the fulfillment center is less than the threshold value;
transmitting the second discount price information regarding the item to a device of the user for display on a user interface on the device; and
in response to the user purchasing the item based on the second discount price information displayed on the user interface, causing the item to be delivered from the fulfillment center to the delivery destination;
wherein discount benefit information associated with at least one of the one or more promotional events are applied to the first discount price information and the second discount price information based on whether each of the one or more promotional events are valid.

14. The electronic apparatus of claim 13, wherein the processor is configured to perform steps of :
selecting the one or more promotional events corresponding to a highest discount price based on information related to at least one of: whether each of the promotional events is redundantly applicable, a discount amount, a discount rate, or a discount limit, and
providing the discount price information regarding the item, wherein the selected one or more promotional events are applied to the discount price information.

15. The electronic apparatus of claim 13, wherein the processor configured to perform steps of: confirming the one or more promotional events that have not expired based on at least one of: preset usage period or usage count-related conditions among the promotional events.
